(19) United States
(12) Patent Application Publication
(10) Pub. No.: US 2018/0292943 A1
(43) Pub. Date: Oct. 11, 2018

(54) Video Touch Sample Blanking to Avoid Noise on Pen and Touch

(71) Applicant: Dell Products L.P., Round Rock, TX (US)

(72) Inventors: Jace W. Files, Round Rock, TX (US); Yagiz C. Yildiz, Austin, TX (US); Lawrence A. Stone, Austin, TX (US)

(73) Assignee: Dell Products L.P., Round Rock, TX (US)

(21) Appl. No.: 15/483,081

(22) Filed: Apr. 10, 2017

(51) Int. Cl. G06F 3/041

(52) U.S. Cl. CPC G06F 3/0418; G06F 3/03545

(57) ABSTRACT

A system, method, and computer-readable medium are disclosed for performing a display device noise reduction operation. In certain embodiments, the display device noise reduction operation synchronizes the clocks between a Scalar clock signal (e.g., a Master clock), a touch device (such as an active pen type touch device), and touch controller clock signals. Additionally, in certain embodiments, a line sample blanking signal (SAMPLE_BLANK) is routed to a pen controller such as an EMR pen controller and a touch controller. The line sample blanking signal being asserted indicates that the display is clocking in a line of the display.

### BACKGROUND OF THE INVENTION

### Field of the Invention

The present invention relates to information handling systems. More specifically, embodiments of the invention relate to reducing noise to a display when sensing touch.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A system, method, and computer-readable medium are disclosed for performing a display device noise reduction operation. In certain embodiments, the display device noise reduction operation synchronizes the clocks between a Scalar clock signal (e.g., a Master clock), a touch device (such as an active pen type touch device), and touch controller clock signals. With many known touch sensitive type display devices all of these separate systems generate their own respective clock signals and have no awareness of each other. With some known touch sensitive type display devices, the Scalar clock signal frequency is fixed in one of two ways. In a free run mode of operation, the Scalar clock signal frequency is locked to a fixed frequency. In a pass through mode of operation, a Host device (e.g., the processor of the information handling system) sets the frequency of the Scalar clock signal.

In certain embodiments, the display device noise reduction operation uses the Scalar clock signal from the Scalar and multiplies and divides the Scalar clock signal to support pen and touch frequencies. With the frequencies synchronized, the active pen and touch sampling is timed to only sample when the display device is not clocking in a new line. Additionally, the pen and touch are synchronized to not sample simultaneously. In certain embodiments, the Hsync clock signal frequency is set to 60*1440=86.4 kHz, the EMR clock signal frequency is set to 593.75 kHz and the touch clock signal frequency is set to 35.4 kHz.

Additionally, in certain embodiments, a line sample blanking signal (SAMPLE_BLANK) is routed to a pen controller such as an EMR pen controller and a touch controller. The line sample blanking signal being asserted indicates that the display is clocking in a line of the display. In certain embodiments, a line of the display requires approximately 100 ns (+/−10%) to clock in. Any time other than the clock in time is considered non-clock in time. The non-clock in time corresponds to a substantial amount of time (e.g., 1000 or more times of the clock in time) during which a display device noise reduction operation for a pen sample or touch sample may occur. In certain embodiments, this non-clock in time for a pen sample or touch sample is substantially 11,500 ns (e.g., +/−10%) for a pen or touch sample to occur. In various embodiments, the clock frequencies of touch clock frequency and the pen clock frequency are asynchronous. When the touch clock signal and the pen clock signal can align, a common voltage reference (VCOM) noise event could potentially occur several times per second. However, by generating a blanking period for the horizontal line and ignoring pen and touch samples that are taken during the blanking period, a noise event is avoided while maintaining acceptable sampling that does not impact touch and pen performance.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an information handling system having a system for display device noise reduction.

FIG. 2 shows a block diagram of a display device environment having a system for display device noise reduction.

FIG. 3 shows a cross section of an exemplative display.

FIGS. 4A, 4B and 4C, show test results of sample display noise levels.

FIGS. 5A, 5B and 5C, show test results of sample display noise levels.

FIGS. 6A, 6B and 6C show test results of sample display noise levels when a display device noise reduction operation is performed.

### DETAILED DESCRIPTION

Various aspects of the present disclosure include an appreciation that on large format monitors and displays (e.g., monitors and display having a diagonal greater than 20 inches), the source driver clocking of each display row can generate excessive noise due to an in rush of current to and from VCOM from the source drivers. This noise can cause an impact to a signal to noise ratio (SNR) on pen (including active pens such as electro-magnetic resonance (EMR) type pens and capacitive type pens) actuation and touch actuation on a periodic basis, based on a display horizontal synchronization (Hsync) clock signal. Pen type touch devices are also often referred to as stylus type touch devices. Such a result can impact user experience. More specifically, the impact to the user experience can include lowered touch and/or pen accuracy as well as pen jitter (i.e., a deviation of the presentation representing a shape drawn using the pen from the shape drawn using the pen).

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

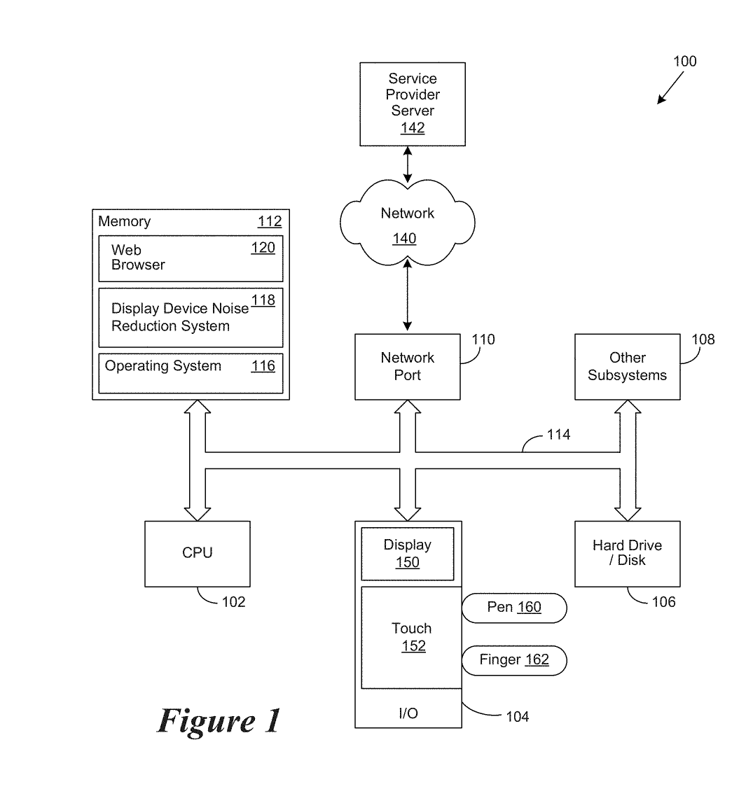

FIG. 1 shows a block diagram of an information handling system having a system for display device noise reduction that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a display device noise reduction system 118 and a web browser 120. In one embodiment, the information handling system 100 is able to download the display device noise reduction system 118 from the service provider server 142. In another embodiment, the display device noise reduction system 118 is provided as a service from the service provider server 142.

The I/O devices 104 further include a display device 150 as well as a touch sensitive input device 152. The touch sensitive input device 152 may be a touch pad and/or a touch sensitive type display device. In various embodiments, the touch sensitive type display device includes a large format (e.g., a greater than 20 inch diagonal) touch sensitive display device. It will be appreciated that the display device 150 may be integrated within the information handling system 100 or may be a separate display device which is coupled to communicate with the information handling system.

A pen 160 or finger 162 may be used to interact with the touch sensitive input device 150. The pen 160 may be a passive pen or may be an active pen. In various embodiments, the passive pen may be used to write directly onto the screen of a touch sensitive display device. In various embodiments, the active pen includes electronic components which allow a user to write directly onto the screen of the display device. In certain embodiments, the active pen generates signals (such as wireless signals) which can be detected by a digitizer of the display device and then provided to a dedicated controller within the display device. In certain embodiments, the active pen further includes at least one function button which can be used in place of a mouse or keyboard. In certain embodiments, the active pen includes a fine tip portion and a blunt portion (also sometimes referred to as the “eraser” portion).

In certain embodiments, the display device noise reduction system 118 performs a display device noise reduction operation which synchronizes the clocks between a Scalar clock signal (e.g., a Master clock), a touch device (such as an active pen type touch device), and touch controller clock signals. In certain embodiments, the active pen may be an electro-magnetic resonance (EMR) pen.

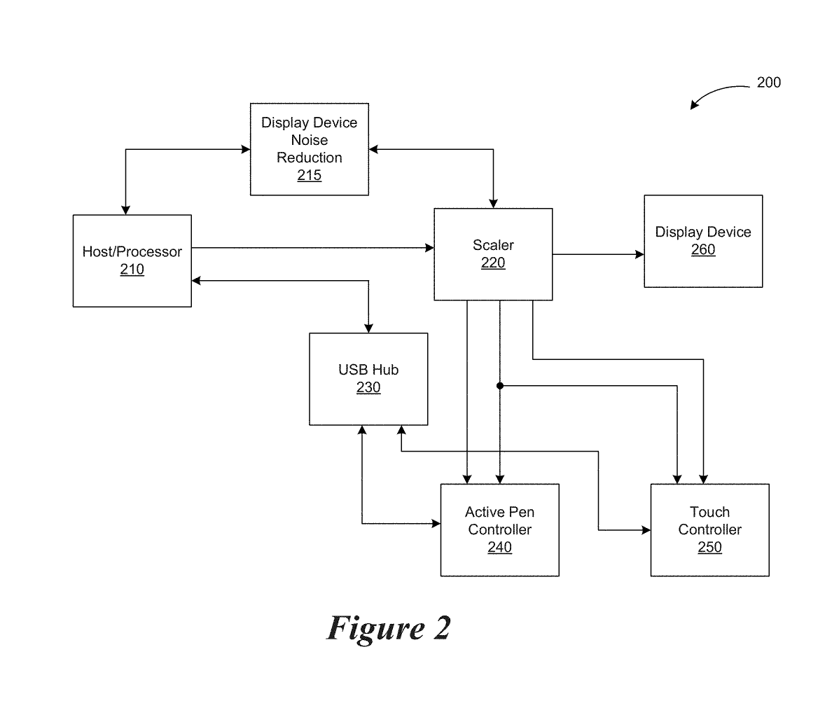

FIG. 2 shows a block diagram of a display device environment 200 having a system for display device noise reduction. The display device environment 200 includes a host processor 210 which may be located within an information handling system such as information handling system 100 or within a display device such as display device 150 as well as a display device noise reduction system 215. It will be appreciated that the display device noise reduction system 215 may be included within the host processor 210, the scaler system 220 or any combination of the various components of the display device environment 200. The display device environment further includes a scaler system 220, a universal serial bus (USB) hub 230, a pen controller 240, a touch controller 250 and a touch sensitive display 260. In certain embodiments, the touch sensitive display 260 is oversized (e.g., having a diagonal greater than 20 inches).

The host processor 210 provides a display port (DP) signal to the scaler system 220. The host processor 210 also provides and receives USB signals (such as USB 2.0 signals) to the USB hub 230. The display device noise reduction system 215 provides control signals to the scaler system 220. The scaler system 220 provides an active pen clock signal (EMR_CLK) and a blanking signal (BLANK) to the pen controller 240. The scaler system 220 provides a touch clock signal (TOUCH_CLK) and the blanking signal (BLANK) to the touch controller 250. The scaler system 220 also provides a low voltage differential signaling (LVDS) signal to the display 260. The USB hub 230 provides and receives USB signals (such as USB 2.0 signals) to the pen controller 240 and the touch controller 250.

In certain embodiments, display device noise reduction system 215 performs a display device noise reduction operation which synchronizes the clocks between a scalar clock signal (e.g., a master clock), a touch device clock signal (such as pen type touch device), and a touch controller clock signal. In certain embodiments, the display device noise reduction operation uses the scalar clock signal from the scalar system 220 and multiplies and divides the scalar clock signal to support pen and touch frequencies. With the frequencies synchronized, the active pen and touch sampling is timed to only sample when the display device 260 is not clocking in a new line. Additionally, the pen and touch are synchronized to not sample simultaneously. In certain embodiments, the Hsync clock signal frequency is set to 60*1440=86.4 kHz, the active pen clock signal frequency is set to 593.75 kHz and the touch clock signal frequency is set to 35.4 kHz. In certain embodiments, the active pen clock signal frequency is set to 562.5 kHz when sampling an active pen tip, to 531.25 kHz when sampling an active pen button and 593.75 kHz when sampling an active pen blunt end.

Additionally, in certain embodiments, a line sample blanking signal (SAMPLE_BLANK) is routed to the pen controller 240 and the touch controller 250. The line sample blanking signal provides an indication to the pen controller 240 and the touch controller 250 to ignore pen and touch sample from the particular line for a predetermined amount of time. In certain embodiments, the predetermined amount of time corresponds to a time for one line of the display to be sampled. In certain embodiments, the line sample blanking signal has an active time which is based upon the frequency of the pen clock signal and the touch clock signal. In certain embodiments, the active time corresponding to frequency of the pen further includes an active pen tip active time, an active pen button active time and an active pen blunt end active time.

The line sample blanking signal being asserted indicates that the display 260 is clocking in a line of the display. In certain embodiments, a line of the display requires approximately 100 ns (+/−10%) to clock in. Clock in refers to the time it takes for the source drivers to charge the LCD capacitors of a row of the display where each row is clocked in simultaneously. The inrush of current from the charging generates noise on the common voltage signal path (which is located on the other side of the capacitors being charged). Any time other than the clock in time is considered non-clock in time. The non-clock in time corresponds to a substantial amount of time (e.g., 1000 or more times of the clock in time) during which a display device noise reduction operation for a pen sample or touch sample may occur. In certain embodiments, this non-clock in time for a pen sample or touch sample is substantially 11,500 ns (e.g., +/−10%) for a pen or touch sample to occur. In various embodiments, the touch clock frequency and the pen clock frequency are asynchronous. When the touch clock signal and the pen clock signal align, a common voltage reference (VCOM) noise event could potentially occur several times per second. However, by generating a blanking period for the horizontal line and ignoring pen and touch samples that are taken during the blanking period, a noise event is avoided while maintaining acceptable sampling that does not impact Touch and Pen performance.

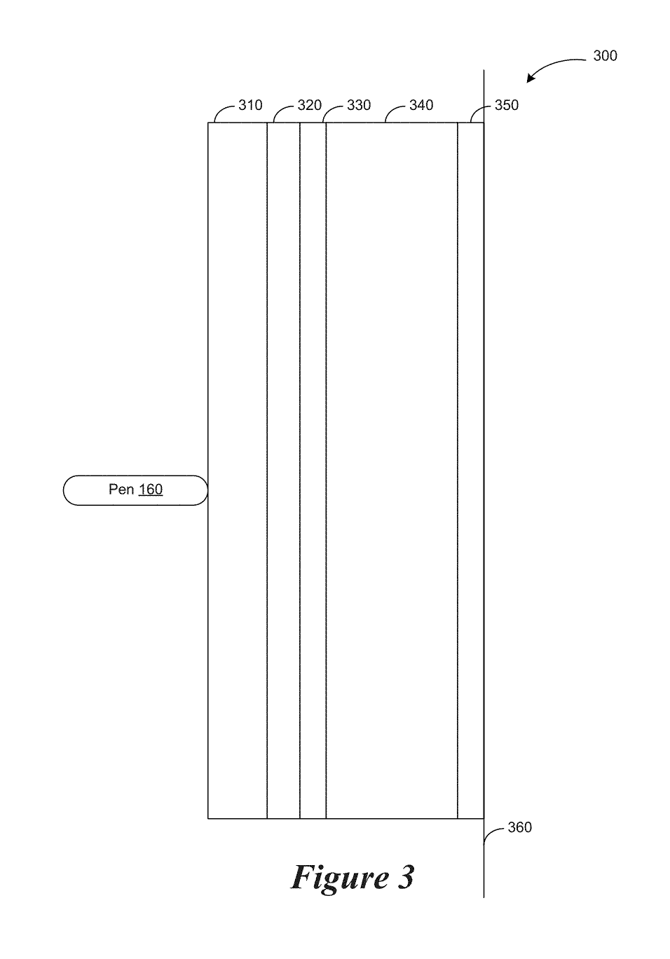

FIG. 3 shows a schematic cross section of an exemplative display 300 (which may correspond to display 260). More specifically, the display 300 includes a front glass layer 310, a touch sensor film layer 320, a liquid crystal display layer 330, a backlight layer 340, a digitizer layer 350 and an electromagnetic interference shield layer 360. In certain embodiments, the digitizer layer 350 includes an EMR digitizer.

The front glass layer 310 provides a protective and environmental insulation function for the display 300. The touch sensor film layer 320 senses touch applied to the front glass layer 310. The liquid crystal display layer 330 includes a liquid crystal display which provides the display function for the display 300. The backlight layer 340 functions in conjunction with the liquid crystal display layer 330 and provides a backlight function for the display 300. The digitizer layer 350 senses when an active pen touches the front glass layer 310.

In certain embodiments, the front glass layer 310 is approximately (i.e., +/−20%) 1.0 mm thick. In certain embodiments, the touch sensor film layer 320 is approximately (i.e., +/−20%) 0.2 mm thick. In certain embodiments, the liquid crystal display layer 330 is approximately (i.e., +/−20%) 1.0 mm thick. In certain embodiments, the backlight layer 340 is approximately (i.e., +/−20%) 3.0 mm thick. In certain embodiments, the digitizer layer 350 is approximately (i.e., +/−20%) 0.6 mm thick.

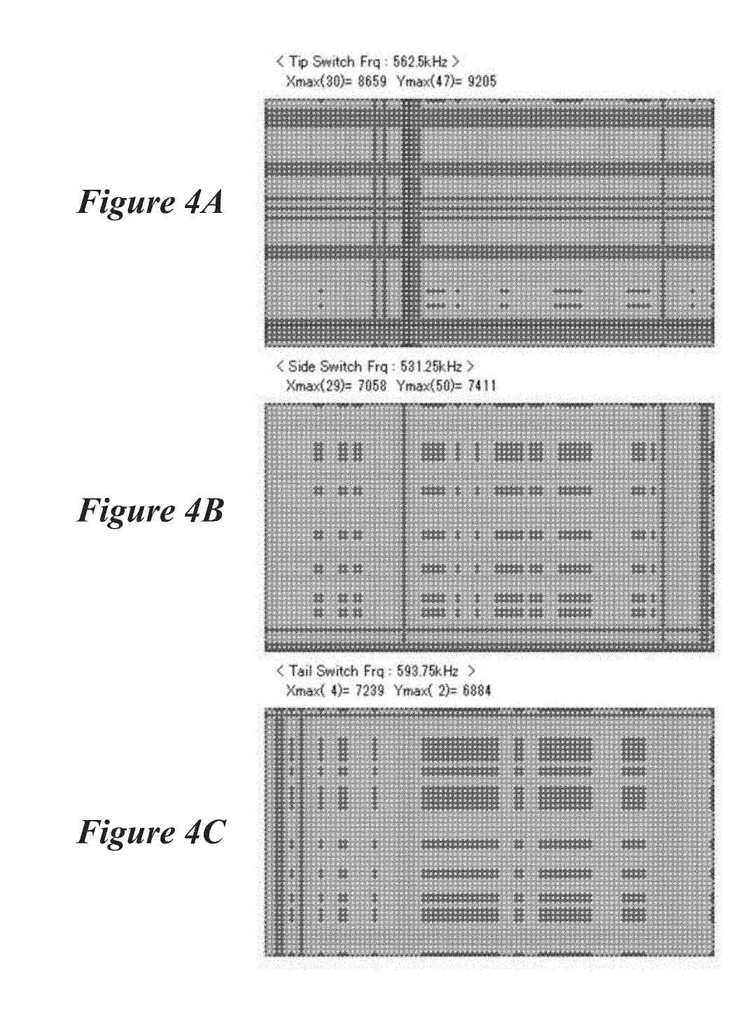

Referring to FIGS. 4A, 4B and 4C, test results of sample display noise levels are shown. More specifically, FIG. 4A shows test results of sample display noise levels when an active pen tip is applied to a display. FIG. 4B shows test results of sample display noise levels when a button on an active pen is actuated and the active pen tip is applied to a display. FIG. 4C shows test results of sample display noise levels when a blunt end of an active pen is applied to a display.

In certain embodiments, the active pen clock signal when an active pen tip is applied to a display has a frequency of 562.4 kHz. In certain embodiments, the active pen clock signal when a button on an active pen is actuated and an active pen tip is applied to a display has a frequency of 531.25 kHz. In certain embodiments, the active pen clock signal when blunt end of an active pen is applied to a display has a frequency of 593.75 kHz.

In certain embodiments, when an active pen tip is applied to a display, the maximum horizontal noise level has a noise level value of 8659 and the maximum vertical noise level has a noise level of 9205. In certain embodiments, when a button on an active pen is actuated and an active pen tip is applied to a display, the maximum horizontal noise level has a noise level value of 7508 and the maximum vertical noise level has a noise level of 7411. In certain embodiments, the active pen clock signal when blunt end of an active pen is applied to a display, the maximum horizontal noise level has a noise level value of 7239 and the maximum vertical noise level has a noise level of 6884. When a noise level is above a predefined acceptable noise value (e.g., 5333), the signal to noise ratio is high enough to adversely affect the performance of the display when an active pen touches the display. For example, one example of an adverse effect to the performance of the display is pen jitter when the pen is touched to the display. For example, in FIGS. 4A, 4B and 4C, horizontal lines 410 and vertical lines 420 represent lines that have a noise level above the predefined acceptable noise value.

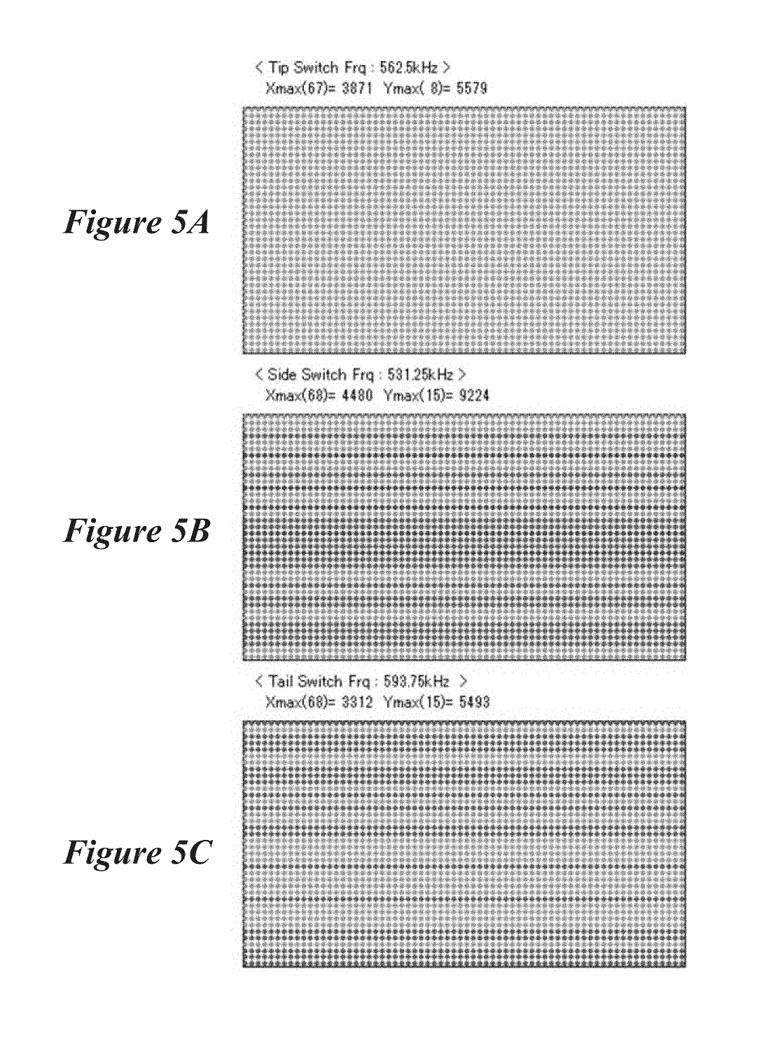

Referring to FIGS. 5A, 5B and 5C, test results of sample display noise levels are shown. More specifically, FIG. 5A shows test results of sample display noise levels of a touch layer (such as touch sensor film layer 320) when an active pen tip is applied to a display. FIG. 5B shows test results of sample display noise levels of a touch layer (such as touch sensor film layer 320) when a button on an active pen is actuated and the active pen tip is applied to a display. FIG. 5C shows test results of sample display noise levels of a touch layer (such as touch sensor film layer 320) when a blunt end of an active pen is applied to a display.

In certain embodiments, the active pen clock signal when an active pen tip is applied to a display has a frequency of 562.4 kHz. In certain embodiments, the active pen clock signal when a button on an active pen is actuated and an active pen tip is applied to a display has a frequency of 531.25 kHz. In certain embodiments, the active pen clock signal when blunt end of an active pen is applied to a display has a frequency of 593.75 kHz.

In certain embodiments, when an active pen tip is applied to a display, the maximum horizontal noise level has a noise level value of 3871 and the maximum vertical noise level has a noise level of 5579. In certain embodiments, when a button on an active pen is actuated and an active pen tip is applied to a display, the maximum horizontal noise level has a noise level value of 4480 and the maximum vertical noise level has a noise level of 9224. In certain embodiments, the active pen clock signal when blunt end of an active pen is applied to a display, the maximum horizontal noise level has a noise level value of 3312 and the maximum vertical noise level has a noise level of 5493. When a noise level is above a predefined acceptable noise value (e.g., 5333), the signal to noise ratio is high enough to adversely affect the performance of the display when an active pen touches the display. For example, one example of an adverse effect to the performance of the display is pen jitter when the pen is touched to the display. For example, in FIGS. 5A, 5B and SC, horizontal lines 510 represent lines that have a noise level above the predefined acceptable noise value.

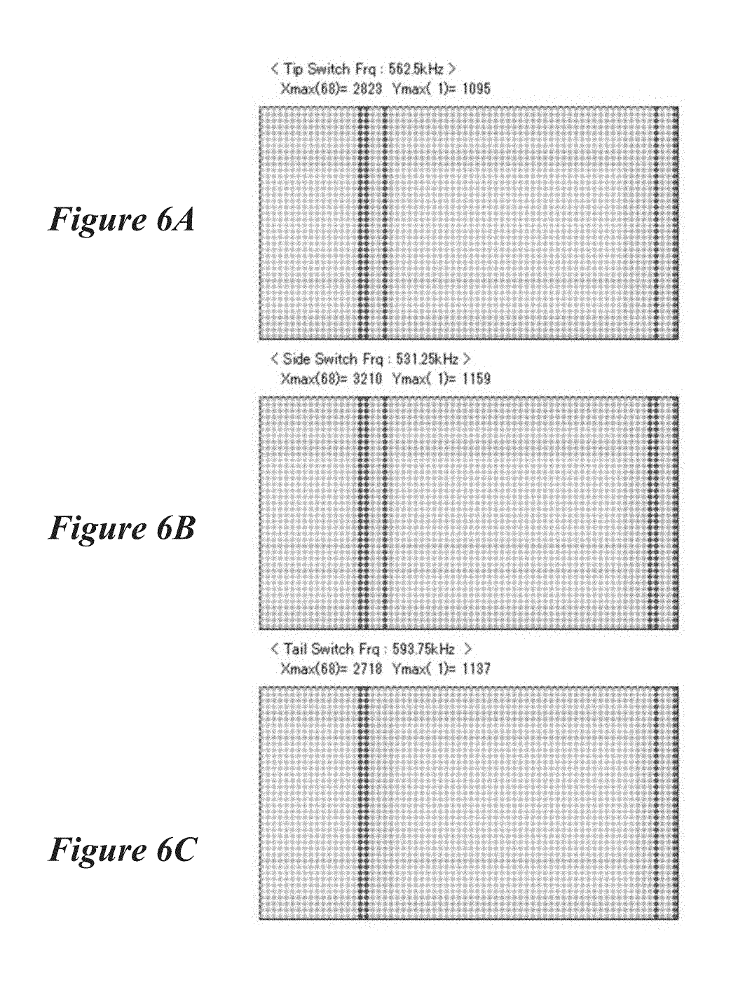

FIGS. 6A, 6B and 6C show test results of sample display noise levels when a display device noise reduction operation is performed. More specifically, FIG. 6A shows test results of sample display noise levels when an active pen tip is applied to a display. FIG. 6B shows test results of sample display noise levels when a button on an active pen is actuated and the active pen tip is applied to a display. FIG. 6C shows test results of sample display noise levels of a touch layer when a blunt end of an active pen is applied to a display.

In certain embodiments, the active pen clock signal when an active pen tip is applied to a display has a frequency of 562.4 kHz and thus an active pen tip blanking signal is set based upon this frequency. In certain embodiments, the active pen clock signal when a button on an active pen is actuated and an active pen tip is applied to a display has a frequency of 531.25 kHz and thus an active pen button blanking signal is set based upon this frequency. In certain embodiments, the active pen clock signal when blunt end of an active pen is applied to a display has a frequency of 593.75 kHz and thus an active pen blunt end blanking signal is set based upon this frequency.

In certain embodiments, when an active pen tip is applied to a display, the maximum horizontal noise level has a noise level value of 2823 and the maximum vertical noise level has a noise level of 1095. In certain embodiments, when a button on an active pen is actuated and an active pen tip is applied to a display, the maximum horizontal noise level has a noise level value of 3210 and the maximum vertical noise level has a noise level of 1159. In certain embodiments, the active pen clock signal when blunt end of an active pen is applied to a display, the maximum horizontal noise level has a noise level value of 2718 and the maximum vertical noise level has a noise level of 1137. For example, in FIGS. 6A, 6B and 6C, vertical lines 610 represent lines that have the highest noise level of the example test results and even the lines with the highest noise level are below the predefined acceptable noise value. Thus, by performing the display device noise reduction operation the noise level is above a predefined acceptable noise value (e.g., 5333), the signal to noise ratio is low enough to avoid adversely affecting the performance of the display when an active pen touches the display.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for reducing display device noise, comprising:
synchronizing a master clock signal, a pen clock signal and a touch clock signal;
generating a blanking signal based upon the pen clock signal and the touch clock signal, the blanking signal indicating to a display the display is clocking in a line of the display, the blanking signal causing the display to ignore pen and touch samples that are taken from the line of the display during a blanking period set forth by the blanking signal being active.

2. The method of claim 1, wherein:
synchronizing the master clock signal, the pen clock signal and the touch clock signal is performed by multiplying and dividing a scalar clock signal to support pen and touch frequencies, by synchronizing the master clock signal, the pen clock signal and the touch clock signal pen and touch sampling is timed to only sample when the display device is not clocking in a new line.

3. The method of claim 1, wherein:
the pen clock signal is associated with an active pen.

4. The method of claim 3, wherein:
the active pen comprises an active pen tip, an active pen button and an active pen blunt end, and
the pen clock signal comprises an active pen tip frequency, an active pen button frequency and an active pen blunt end frequency.

5. The method of claim 4, wherein:
the blanking signal has an active pen tip time period based upon the active pen tip frequency, an active pen button time period based upon the active pen button frequency and an active pen blunt end time period based upon the active pen blunt end frequency; and,
the active pen tip time period is used when the display senses the active pen tip, the active pen button time period is used when the display senses the active pen button and the active pen blunt end time period is used when the display senses the active pen blunt end.

6. The method of claim 3, wherein:
the active pen comprises an electro-magnetic resonance (EMR) type active pen.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
synchronizing a master clock signal, a pen clock signal and a touch clock signal;
generating a blanking signal based upon the pen clock signal and the touch clock signal, the blanking signal indicating to a display the display is clocking in a line of the display, the blanking signal causing the display to ignore pen and touch samples that are taken from the line of the display during a blanking period set forth by the blanking signal being active.

8. The system of claim 7, wherein:
synchronizing the master clock signal, the pen clock signal and the touch clock signal is performed by multiplying and dividing a scalar clock signal to support pen and touch frequencies, by synchronizing the master clock signal, the pen clock signal and the touch clock signal pen and touch sampling is timed to only sample when the display device is not clocking in a new line.

9. The system of claim 7, wherein:
the pen clock signal is associated with an active pen.

10. The system of claim 9, wherein:
the active pen comprises an active pen tip, an active pen button and an active pen blunt end, and
the pen clock signal comprises an active pen tip frequency, an active pen button frequency and an active pen blunt end frequency.

11. The system of claim 10, wherein:
the blanking signal has an active pen tip time period based upon the active pen tip frequency, an active pen button time period based upon the active pen button frequency and an active pen blunt end time period based upon the active pen blunt end frequency; and,
the active pen tip time period is used when the display senses the active pen tip, the active pen button time period is used when the display senses the active pen button and the active pen blunt end time period is used when the display senses the active pen blunt end.

12. The system of claim 9, wherein:
the active pen comprises an electro-magnetic resonance (EMR) type active pen.

13. A non-transitory, computer-readable storage medium embodying computer program code, the computer program code comprising computer executable instructions configured for:
synchronizing a master clock signal, a pen clock signal and a touch clock signal;
generating a blanking signal based upon the pen clock signal and the touch clock signal, the blanking signal indicating to a display the display is clocking in a line of the display, the blanking signal causing the display to ignore pen and touch samples that are taken from the line of the display during a blanking period set forth by the blanking signal being active.

14. The non-transitory, computer-readable storage medium of claim 13, wherein:
synchronizing the master clock signal, the pen clock signal and the touch clock signal is performed by multiplying and dividing a scalar clock signal to support pen and touch frequencies, by synchronizing the master clock signal, the pen clock signal and the touch clock signal pen and touch sampling is timed to only sample when the display device is not clocking in a new line.

15. The non-transitory, computer-readable storage medium of claim 13, wherein:
the pen clock signal is associated with an active pen.

16. The non-transitory, computer-readable storage medium of claim 15, wherein:
the active pen comprises an active pen tip, an active pen button and an active pen blunt end, and
the pen clock signal comprises an active pen tip frequency, an active pen button frequency and an active pen blunt end frequency.

17. The non-transitory, computer-readable storage medium of claim 16, wherein:
the blanking signal has an active pen tip time period based upon the active pen tip frequency, an active pen button time period based upon the active pen button frequency and an active pen blunt end time period based upon the active pen blunt end frequency; and,
the active pen tip time period is used when the display senses the active pen tip, the active pen button time period is used when the display senses the active pen button and the active pen blunt end time period is used when the display senses the active pen blunt end.

18. The non-transitory, computer-readable storage medium of claim 13, wherein:
the active pen comprises an electro-magnetic resonance (EMR) type active pen.
